(19) United States
(12) Patent Application Publication
(10) Pub. No.: US 2011/0240261 A1
(43) Pub. Date: Oct. 6, 2011

(54) METHOD FOR HEAT EXCHANGE, SYSTEM AND USE

(75) Inventors: Jarl Ahlbeck, Turku (FI); Kurt Lundqvist, Parainen (FI); Ida Rönnlund, Turku (FI); Tapio Westerlund, Turku (FI); Kari Luukko, Espoo (FI); Vesa Sorri, Espoo (FI)

(73) Assignee: UPM-KYMMENE CORPORATION, Helsinki (FI)

(21) Appl. No.: 13/139,069

(22) PCT Filed: Dec. 4, 2009
(86) PCT No.: PCT/FI2009/050976

§ 371 Date: Jun. 10, 2011

(30) Foreign Application Priority Data
Dec. 19, 2008 (FI) 20086218

(51) Int. Cl. B01J 19/00; F28D 15/00

(52) U.S. Cl. 165/104.11; 422/198

(57) ABSTRACT

A method, system and use for heat exchange in super-critical or near-critical water gasification process of biomass. The method comprising steps of: heating a biomass in a first heat exchanger (6) by thermal energy of a heat transfer medium, reacting the biomass in said super-critical or near-critical water gasification process and producing reaction products, cooling the reaction products of the biomass in a second heat exchanger (12) by absorbing the thermal energy of the reaction products to said heat transfer medium, and circulating said heat transfer medium between the first heat exchanger (6) and the second heat exchanger (12), wherein molten salt is used as the heat transfer medium.

### FIELD OF THE INVENTION

The invention relates to a method for heat exchange in super-critical or near-critical water gasification process of biomass, the method comprising steps of: heating a biomass in a first heat exchanger by thermal energy of a heat transfer medium, reacting the biomass in said super-critical or near-critical water gasification process and producing reaction products, cooling the reaction products of the biomass in a second heat exchanger by absorbing the thermal energy of the reaction products to said heat transfer medium, and circulating said heat transfer medium between the first heat exchanger and the second heat exchanger.

The invention further relates to a system for heat exchange in super-critical or near-critical water gasification process of biomass, the system comprising, a first heat exchanger for heating said biomass, a second heat exchanger for cooling reaction products of said super-critical or near-critical water gasification process, and a circulation system for circulating heat transfer medium between the first heat exchanger and the second heat exchanger.

The invention also relates to a use.

The method and apparatus of the invention can be used in processes and systems treating biomass and converting these to gaseous or liquid fuels or base components for further refining.

### BACKGROUND OF THE INVENTION

Research in the area of a hydrothermal gasification/liquefaction process conducted at high pressure and high temperature dates back to 1978, when J. Model discovered that supercritical water, i.e. water at conditions where the temperature is above 374° C. and the pressure is at least 221 bar, can be used to gasify organic material when supercritical water was used as a medium. The method has been further developed by a few research groups to include liquefaction, as well as gasification, of various wet biomass feeds in both near critical water, i.e. pressure of water at least 150 bar and temperature above 300° C., and supercritical water.

The process has potentials to gasify, for instance, waste sludge in the pulp and paper industry and to separate organic matter from inorganic. While the organic matter is gasified mainly to hydrogen, methane, carbon dioxide and carbon monoxide, the inorganic matter can be separated mechanically from the liquid phase. Gasification occurs around 450-700° C. depending on the material that is gasified, the prevailing process conditions and whether catalysts are used or not.

Due to the high temperature, high pressure and high water content, the process is highly energy consuming. Therefore, there is a need for an internal heat recovery or exchange system that heats up incoming streams of reactants, additives and catalysts with heat energy absorbed from discharged hot stream of reacted material.

It is known to use heat exchangers in hydrothermal gasification and/or liquefaction process equipment in order to improve the efficiency of use of energy. Unfortunately, due to the extremely demanding process conditions and inhomogeneous character of biomass, known heat exchangers do not work well in hydrothermal gasification and/or liquefaction processes.

One serious problem with conventional tube heat exchangers is that there is a high pressure on both sides of the tubes, i.e. the material flow inside the tubes and the heat transfer medium outside the tubes must be pressurized to a high pressure, e.g. 221 bar, in order to get the temperature high enough. This means that the shell of the heat exchanger must be manufactured to be pressure resistant, that is, very thick and therefore expensive.

Another problem associated with the heat exchangers is caused by low heating rates. This causes accumulating of tar, char etc. solids or high viscosity fluids on the surfaces of flow channels of the heat exchangers, thus causing increasing flow resistance and clogging in said channels. For example, experiments where commonly known double wall type heat exchangers or double pipe type heat exchangers have been arranged in process equipment have failed due to the clogging (Biljana Potic, D.Sc. dissertation 2006, Universiteit Twente, ISBN 90-365-2367-2).

### BRIEF DESCRIPTION OF THE INVENTION

It is thus an object of the present invention to provide a method and a system so as to alleviate the above disadvantages. The objects of the invention are achieved by a method and a system which are characterized by what is stated in the independent claims. The preferred embodiments of the invention are disclosed in the dependent claims.

An idea of the method of the invention is that the method comprises steps of: heating a biomass in a first heat exchanger by thermal energy of a heat transfer medium, reacting the biomass in said super-critical or near-critical water gasification process and producing reaction products, cooling the reaction products of the biomass in a second heat exchanger by absorbing the thermal energy of the reaction products to said heat transfer medium, and circulating said heat transfer medium between the first heat exchanger and the second heat exchanger, wherein molten salt is used as the heat transfer medium.

An idea of the system of the invention is that it comprises a first heat exchanger for heating said biomass, a second heat exchanger for cooling reaction products of said super-critical or near-critical water gasification process, and a circulation system for circulating heat transfer medium between the first heat exchanger and the second heat exchanger, wherein the heat transfer medium is molten salt.

An idea of the use of the invention is that a molten salt is used as a heat transfer medium in a process of super-critical or near-critical water gasification of biomass.

An idea of the second use of the invention is that a molten salt is used as a heat transfer medium in a process of super-critical or near-critical water gasification of biomass, the process comprising: heating a biomass in a first heat exchanger by thermal energy of the heat transfer medium, reacting the biomass in said super-critical or near-critical water gasification process and producing reaction products, cooling the reaction products of the biomass in a second heat exchanger by absorbing the thermal energy of the reaction products to said heat transfer medium, and circulating said heat transfer medium between the first heat exchanger and the second heat exchanger.

An advantage of the method and system of the invention is that the heating rate of the biomass can be kept high when molten salt is used as a heat transfer medium and, therefore, accumulation of tar, char etc. solids or high viscosity fluids on the surfaces of flow channels of the heat exchanger may be avoided or, at least, substantially reduced. It has been noted, that the accumulation of solids or high viscosity fluids takes place if temperature of the biomass is in a temperature range of about 200-400° C. In addition, corrosive reactions occur intensively in said range of temperature, thus shortening the life time of the apparatus. These disadvantages that occur when the heating rate of the biomass is too slow, can be avoided by using molten salt as heat transfer medium. Since molten salt has good heat transfer properties, the heating rate can be increased and the critical temperature range can be passed rapidly.

Another advantage of the method and system of the invention is that high temperatures needed for hydrothermal gasification and/or liquefaction of biomass can be reached quickly, resulting a more efficient process and higher capacity of processing equipment.

Still another advantage of the method and system of the invention is that the pressure of the molten salt may be kept low without sacrificing heat exchange capacity of the heat exchangers.

Still another advantage is that only the tubes transporting the biomass need to be pressure resistant. The heat transfer medium surrounding the tubes may be in low pressure, e.g. in atmospheric pressure. The structure carrying the heat transfer medium and enclosing the tubes can thus be manufactured from cheaper materials than in known heat exchangers. Also the construction of the enclosing structure is easy.

An idea of an embodiment of the invention is that the method and the system are integrated with or connected to processes of a Kraft pulp mill and/or a paper mill. This provides the advantage that the Kraft pulp mill and/or the paper mill provide a constant supply for biomass used in the hydrothermal treatment avoiding costly transporting.

### BRIEF DESCRIPTION OF THE DRAWINGS

In the following the invention will be described in greater detail by means of preferred embodiments with reference to the attached drawings, in which

FIG. 1 is a schematic representation of a system and a method of the invention shown as a process flow diagram.

### DETAILED DESCRIPTION OF THE INVENTION

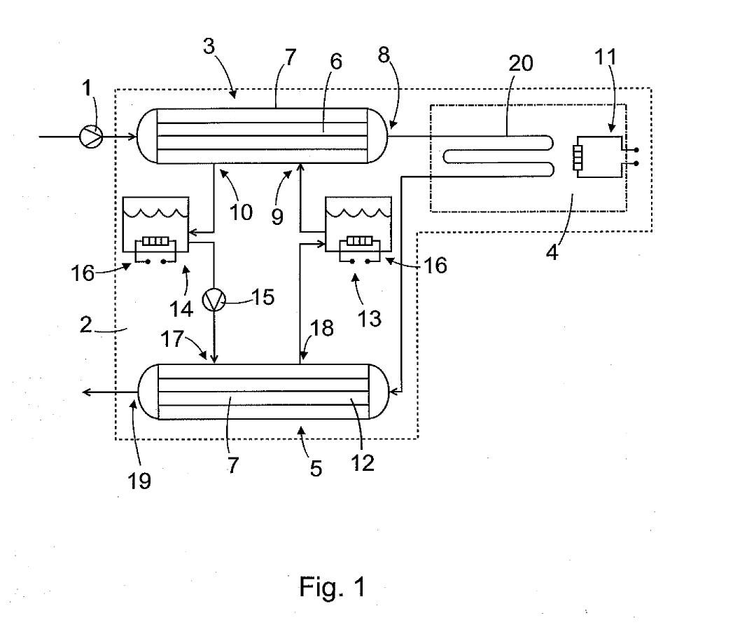

FIG. 1 is a schematic representation of a system and a method of the invention shown as a process flow diagram.

First, a biomass, which is optionally mixed with additives and/or catalysts is pressurized to a desired pressure, for instance in the range of 150-400 bar, by pressurizing means 1 and fed to a reactor system 2. The pressurizing means 1 shown in FIG. 1 comprises a pump. The pressurizing to the desired pressure may take place in one step, for example by one pump, or stepwise, for example by several pumps connected in series.

In another embodiment of the invention there are two or even more streams of biomass, additives and/or catalysts, which are fed separately to the reactor system 2. Said streams mix and form the reaction mixture in the reactor system 2.

The biomass contains typically at least 70 weight-% water. Said water is preferably mainly the moisture i.e. water already present in the biomass. Additional water may be admixed if necessary.

The term “biomass” refers to virgin and waste materials of a plant, animal and/or fish origin, such as municipal waste, industrial waste or byproducts, agricultural waste or by-products (including also dung), waste or byproducts of the wood-processing industry, waste or by-products of the food industry, marine plants (such as algae) and combinations thereof. The biomass material is preferably selected from non-edible resources such as non-edible wastes and non-edible plant materials, including oils, fats and waxes. A preferred biomass material according to the present invention comprises waste and by products of the wood-processing industry such as residue, urban wood waste, lumber waste, wood chips, sawdust, straw, firewood, wood materials, paper sludge, primary and/or secondary sludge, deinking waste sludge, paper, black liquor, by-products of the papermaking or timber processes, short rotation crops etc. Also peat can be used as biomass in the process. Biomass may be a blend comprising water and organic material that has been purposely blended for using in the method and system of the invention.

The method and the system of the invention may be integrated with or connected to processes of a Kraft pulp mill and/or a paper mill. This provides the advantage that the Kraft pulp mill and/or the paper mill provide a constant supply for biomass, additives and/or catalysts used in the hydrothermal treatment avoiding costly transporting. Black liquor may be used not only as biomass but also an additive for enhancing hydrothermal treatment of other biomasses.

The reactor system 2 comprises a heating section 3, a reaction section 4 and a cooling section 5.

The biomass is first heated in the heating section 3. After being heated to a desired temperature, the biomass is fed in the reaction section 4.

When the required reactions have taken place in the reaction section 4, the resulting reaction products are fed to a cooling section 5 where they are cooled down and optionally depressurized.

The heating section 3 is adapted to heat the biomass up or near to the reaction temperature. The main component of the heating section 3 is a first heat exchanger 6. The first heat exchanger 6 is a so called shell and tube heat exchanger, known also as a tube heat exchanger, which comprises a shell 7 and a series of tubes arranged inside the shell 7. The tubes are connected either directly or indirectly, at their first end, to the pressurizing means 1 and, at their second end, to a first outflow channel 8. The reaction mixture runs through said tubes and out from the first heat exchanger 6 via the first outflow channel 8.

The first heat exchanger 6 comprises also a first feed opening 9 and a first discharge opening 10 for feeding and discharging of the heat transfer medium to and from the first heat exchanger 6. The heat transfer medium is arranged to flow in a space between the shell 7 and outer surfaces of the tubes. The heat exchange medium is thus surrounding the heat exchanger tubes and flowing on their outer surfaces. In the embodiment shown in FIG. 1, the first heat exchanger 6 has been arranged to operate counter currently, but also parallel-flow and crossflow constructions are possible ones.

An idea of the invention is that the heat transfer medium is molten salt. The molten salt may be, for instance, one sold under a trade name Hitec®. The melting point of Hitec® salt is about 150° C. and the maximum operation temperature is about 550° C. Hitec® is a eutectic mixture of water-soluble, inorganic salts of potassium nitrate, sodium nitrite and sodium nitrate. Other salts, i.e. pure salt, salt mixtures or salt compositions, may, of course, be used as the heat transfer medium. The viscosity of the molten salt is preferably about 1-10 cp in the temperatures existing in a circulation system of the heat transfer medium. The temperature of the salt is kept above its melting point throughout the process.

A pipe connects the first feed opening 9 with a first salt tank 13 where the molten salt is kept in a high temperature, preferably near the maximum operation temperature of the molten salt. The first salt tank 13 includes a second heater 16, which is preferably an electric heater. Of course another type of heaters may also be used. The second heater is typically used in startup phase of the process. As soon as the temperature of the first salt tank 13 has reached a steady-state, the second heater 16 can be switched off. The second heater 16 may also be used for controlling the process, i.e. maintaining the temperature of the molten salt in a desired level.

Hydrothermal reactions needed for restructuring the biomass take place in the reaction section 4. However, important reactions forming intermediate products may also occur already in the heating section 3.

Said hydrothermal reactions happening in the reaction section 4 are gasification and/or liquefaction reactions which occur at high temperature and high pressure, either in supercritical water, i.e. at temperature above 374° C. and pressure at least 221 bar, or near-critical water, i.e. at temperature above 300° C. and pressure above 150 bar. In supercritical water organic compounds and gases become fully soluble in water, thus reactions can occur in one phase and reaction times are shortened.

As a result of said hydrothermal reactions, organic materials or compounds in the biomass decomposed and restructured under the influence of the hot compressed water. Typically gasification reactions require temperatures of about 500° C. to 700° C., whereas liquefaction reactions require temperatures of about 350° C. to 500° C.

There are several ways to heat the reaction section 4 to a desired reaction temperature. In the reaction section 4 shown in FIG. 1, for instance, the biomass is arranged to run in tubes 20 that are embedded in a salt bed or salt bath comprising a second salt. The second salt serves as a heat transfer medium between said tubes and a first heater device 11. The first heater device 11 has been arranged in the reaction section 4 for maintaining the temperature of the second salt and also the temperature of the biomass at desired level in the reaction section 4. The first heater device 11 is capable of keeping a stable temperature through the whole reaction section 4. The first heater device 11 is, for instance, an electric or gas heater.

The second salt may be, for example sodium chloride blended with a small amount of calcium chloride. The second salt may be in a molten state or in a solid state.

After the required reaction time has passed the reaction products are led to a cooling section 5 where they are cooled down. From the cooling section 5 the reaction products may be led to a separator unit (not shown in the FIGURE) where depressurization and separation of the reaction products take place. The depressurization may also take place in the cooling section 5.

The cooling section 5 comprises a second heat exchanger 12, the structure of which is similar to the first heat exchanger 6. Thus, the second heat exchanger 12 comprises outer shell 7, tubes that are arranged to be in connection to a second outflow channel 19, a second feed opening 17 for receiving the heat transfer medium and a second discharge opening 18 for discharging the heat transfer medium that has run through the second heat exchanger 12.

The heat exchangers 6, 12 are connected to the circulation system of the heat transfer medium so that the heat transfer medium is continuously circulating through the first and second heat exchangers 6, 12. The first salt tank 13, as well as a second salt tank 14 are arranged between the heat exchangers 6, 12 in the circulation system of the heat transfer medium.

The main components of the circulation system of the heat transfer medium are the spaces between the shell 7 and outer surfaces of the tubes in the first and second heat exchangers 6, 12, the first and second salt tanks 13, 14 and a pump 15. Tubes or pipes connect these components to each other. The circulation system of the heat transfer medium is thermally insulated from surroundings.

In the circulation cycle, the molten salt is fed into the first heat exchanger 6 from the first salt tank 13 and discharged from the first heat exchanger 6 into the second salt tank 14. From the second salt tank 14 the molten salt is fed to the second heat exchanger 12, and discharged from it into the first salt tank 13.

The molten salt in the first salt tank 13 has a high temperature, e.g. 400-600° C. In case of Hitec®, the temperature is preferably about 550° C. The first salt tank 13 is arranged to communicate with the first feed opening 9 in the first heat exchanger 6 such that the molten salt having said high temperature is fed in the space between the shell 7 and outer surfaces of the tubes thereof. The structure of the shell 7 may be light and inexpensive because the pressure of the molten salt is low.

The high temperature molten salt gives up heat to the biomass running through the tubes of the first heat exchanger 6, thus raising the temperature of the biomass. As a consequence of this the molten salt cools down. Heat exchange between the molten salt and the reaction mixture takes place quickly and homogenous way in the first heat exchanger 6. Thus, the reaction mixture heats up quickly and ionic reactions producing tar, char etc. solids or high viscosity fluids, can be avoided or limited. Alike, high temperatures needed for radical reactions of hydrothermal gasification and/or liquefaction reactions are reached quickly.

The molten salt, which has cooled down in the first exchanger 6 is discharged from it through the first discharge opening 10 and fed into the second salt tank 14. The temperature of the molten salt received by the second salt tank 14 is, preferably near the melting temperature of the molten salt.

In the second salt tank 14 the temperature of the molten salt is substantially lower than in the first salt tank 13, the temperature being preferably substantially equal to the temperature of the molten salt received from the first heat exchanger 6. Said temperature is, however, above the melting temperature of the salt. In case of Hitec®, the temperature is preferably about 160° C. The second salt tank 14 also includes a second heater 16, which is used in the same way as the second heater of the first salt tank 13.

The molten salt is fed from the second salt tank 14 into the second heat exchanger 12. In the embodiment of the invention shown in FIG. 1, the pump 15 is arranged between the second salt tank 14 and the second heat exchanger 12 and arranged to circulate the molten salt through the circulation system of the heat transfer medium. The pump 15 may also be arranged elsewhere in the system, e.g. between the first heat exchanger 6 and the second salt tank 14. The output rate of the pump 15 may be adjusted so that an optimal flow rate of the molten salt is achieved.

Reaction products produced in the reaction section 4 and being still at high temperature, e.g. about 650° C., are fed in the second heat exchanger 12 for cooling. The temperature of the molten salt is kept below the temperature of the reaction products. The temperature of the molten salt in the second heat exchanger is e.g. about 160° C. Therefore, thermal energy is transferred from the reaction products to the molten salt, whereupon the molten salt is heating up and the reaction products are cooling down. Preferably, the molten salt absorbs the heat from the reaction products in such an amount that it reaches the high temperature that is prevailing in the first salt tank 13. The high temperature molten salt is fed from the second heat exchanger 12 through the discharge opening 18 to the first salt tank 13 and, again, into the first heat exchanger 6. The cooled reaction products are discharged from the second heat exchanger 12 through a second outflow channel 19. Then the cooled reaction products may be depressurized and separated to a gaseous and liquid phase.

It is to be noted and emphasized that the apparatus shown in FIG. 1 is just an alternative to realize the apparatus of the invention. The apparatus may be construed differently. One or both of the heat exchangers 6 and 12, for instance, may be double-tube or tube-in-tube heat exchangers, which employ two, or more, usually concentric, tubes as surfaces for heat transfer and channels for heat transfer medium.

It will be obvious to a person skilled in the art that, as the technology advances, the inventive concept can be implemented in various ways. The invention and its embodiments are not limited to the examples described above but may vary within the scope of the claims.

1.-19. (canceled)

20. A method for heat exchange in a super-critical or near-critical water, i.e. pressure of water at least 150 bar and temperature above 300° C., gasification process of biomass, the method comprising steps of:
heating biomass in a first heat exchanger by thermal energy of a heat transfer medium;
reacting the biomass in said super-critical or near-critical water gasification process and producing reaction products;
cooling the reaction products of the biomass in a second heat exchanger by absorbing the thermal energy of the reaction products to said heat transfer medium;
circulating said heat transfer medium between the first heat exchanger and the second heat exchanger; and
using molten salt as the heat transfer medium.

21. The method according to claim 20, wherein the heat transfer medium comprises a mixture of water-soluble, inorganic salts of potassium nitrate, sodium nitrite and sodium nitrate.

22. The method according to claim 20, further comprising the step of circulating said molten salt through a first salt tank and a second salt tank.

23. The method according to claim 22, further comprising the step of keeping the temperature of the first salt tank near the maximum operation temperature of the molten salt.

24. The method according to claim 22, further comprising the step of keeping the temperature of the second salt tank near the melting temperature of the molten salt.

25. The method according to claim 20, wherein the viscosity of the molten salt is about 1-10 cp.

26. The method according to claim 20, further comprising the step of mixing the biomass with additives and/or catalysts.

27. The method according to claim 20, further comprising the step of reacting products, by-products or waste streams of a Kraft pulp mill and/or a paper mill.

28. The method according to claim 20, further comprising the step of heating the reaction mixture to a temperature of at least 374° C.

29. A reactor system comprising,
a first heat exchanger for heating biomass to be fed in a reaction section, the reaction section being adapted to gasification process of biomass in super-critical or near-critical water,
i.e. pressure of water at least 150 bar and temperature above 300° C.;
a second heat exchanger arranged to cool reaction products of said gasification process taking place in the reaction section; and
a circulation system for circulating heat transfer medium that is molten salt between the first heat exchanger and the second heat exchanger.

30. The system according to claim 29, wherein the molten salt comprises a mixture of water-soluble, inorganic salts of potassium nitrate, sodium nitrite and sodium nitrate.

31. The system according to claim 29, further comprising a first salt tank and a second salt tank and a device configured to circulate said molten salt through said tanks.

32. The system according to claim 31, wherein the temperature of the first salt tank is near the maximum operation temperature of the molten salt.

33. The system according to claim 31, wherein the temperature of the second salt tank is near the melting temperature of the molten salt.

34. The system according to claim 29, wherein the viscosity of the molten salt is arranged to be about 1-10 cp.

35. The system according to claim 29, wherein it is capable to process biomass mixed with additives and/or catalysts.

36. The system according to claim 29, wherein it is capable to process biomass comprising products, by-products or waste streams of a Kraft pulp mill and/or a paper mill.
